(19) United States
(12) Patent Application Publication
(10) Pub. No.: US 2013/0166243 A1
(43) Pub. Date: Jun. 27, 2013

(54) TEST DEVICE AND METHOD FOR TESTING STABILITY OF ELECTRONIC DEVICES

(71) Applicants: JIA-QING HUANG, Shenzhen City (CN); AN-LIN ZHOU, Shenzhen City (CN); ZHEN-SEN LI, Shenzhen City (CN)

(72) Inventors: JIA-QING HUANG, Shenzhen City (CN); AN-LIN ZHOU, Shenzhen City (CN); ZHEN-SEN LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenxhen City (CN)

(21) Appl. No.: 13/600,241

(22) Filed: Aug. 31, 2012

(30) Foreign Application Priority Data
Dec. 27, 2011 (CN) 201110444784.3

(51) Int. Cl. G06F 19/00

(52) U.S. Cl. 702/108

(57) ABSTRACT

A test method includes: setting test parameters for a test of a plurality of electronic devices in response to a user input; generating a control signal according to the test parameters and sending the control signal to a baseboard management controller of each electronic device to control the baseboard management controller to test the corresponding electronic devices according to the parameter set by the user, and recording the number of the time that the start and shut down operation have been done and the test values which can reflect the running state of the electronic devices in a test file; analyzing the stability of each electronic device by analyzing the test result record in the test file. A test device and computer-readable medium are also disclosed.

### BACKGROUND

1. Technical Field

The present disclosure relates to test devices, and particularly, to a test device and a method for testing the stability of a number of electronic devices at the same time.

2. Description of Related Art

Stability testing may be performed during the manufacturing process of a server. In order to test the stability of a server, the server may repeatedly be started and shut down hundreds of times according to a reboot command under a WINDOWS system. However, by using the reboot command to control the servers to repeatedly execute the start and shut down operation, a user may be difficult to set the test parameters, such as a total number of the times that the servers are to be started and shut down in the test, and a time interval between two instances that the servers are started and shut down.

Therefore, what is needed is a means to solve the problems described above.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure.

Moreover, in the drawings, like reference numerals designate corresponding portions throughout the several views.

FIG. 1 is a block diagram of a test device in accordance with an exemplary embodiment.

FIG. 2 is a flowchart of a test method in accordance with an exemplary embodiment.

### DETAILED DESCRIPTION

Embodiments of the present disclosure will now be described in detail, with reference to the accompanying drawings.

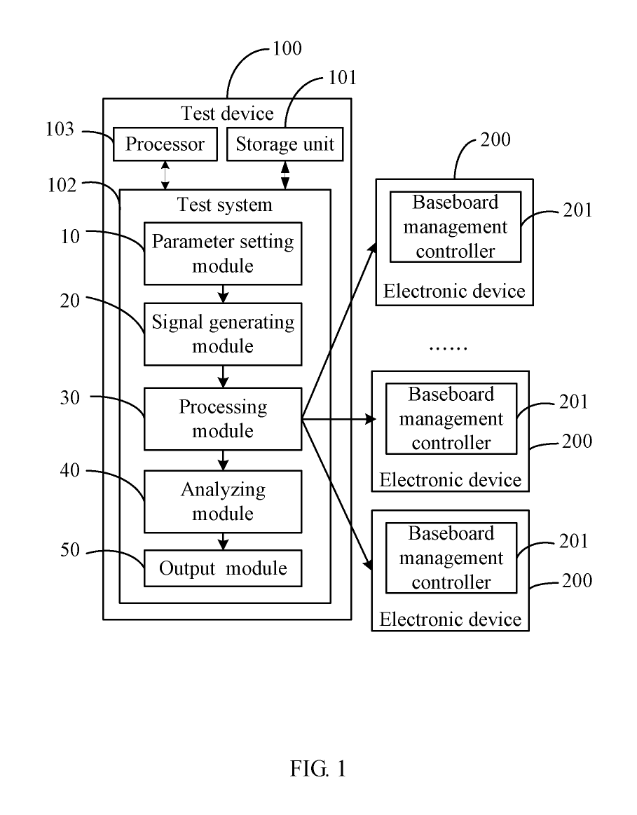

FIG. 1 is a block diagram of a test device 100 according to an exemplary embodiment. The test device 100 is configured to connect to the number of electronic devices 200 via cables or wireless network to simultaneously test the stability of a number of electronic devices 200 by monitoring whether the electronic devices 200 are running in a normal state when the electronic devices 200 are repeatedly start and shut down for hundreds of times, and outputs test results to an operator of the test device 100. In the embodiment, the electronic devices 200 are servers contained in a data center, and each of the electronic devices 200 has a baseboard management controller (BMC) 201 and the BMC 201 of each electronic device 200 includes a unique identifier.

The test device 100 includes a storage unit 101, a test system 102, and a processor 103. In this embodiment, the test system 102 includes a parameter setting module 10, a signal generating module 20, a processing module 30, an analyzing module 40, an output module 50, One or more programs of the above function modules may be stored in the storage unit 101 and executed by the processor 103. In general, the word “module”, as used herein, refers to logic embodied in hardware or firmware, or to a collection of software in instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

The parameter setting module 10 sets test parameters in response to a user input. In the embodiment, the test parameters include a total number of the times that the electronic devices 200 are to be started and shut down in the test, a time interval between two times that the electronic devices 200 are started and shut down, i.e., a pause between two adjacent cycles of starting and shutting-down, items to be tested, such as the software and/or hardware of the electronic device 200 to be tested, and a test content for each item, such as the voltage and the temperature of the electronic device 200. For example, the parameter setting module 10 may set a total number of times that the electronic devices 200 are started and shut down for 1000 times in the test and a time interval between two times that the electronic devices 200 are started and shut down for 2 seconds. In the embodiment, the set test parameters are applied for all the electronic devices 200 to be tested in the test. In an alternative embodiment, the parameter setting module 10 may set different test parameters for different electronic devices 200.

The signal generating module 20 generates a control signal which can be recognized by the BMC 201 of each electronic device 200 according to the test parameters set by the user and sends the control signal to the BMC 201 of each of the electronic devices 200 to control the BMC 201 to test the corresponding electronic device 200 according to the test parameters. In the embodiment, when testing the electronic devices 200, each electronic device 200 is controlled to be started and shut down according to the parameter set by the user, and record the number of times that the start and shut down operation has been done and the test values which can reflect the running state of the electronic devices 200, such as the temperature value and the voltage value of the main board of the electronic device 200, in a test file. In this embodiment, the test file of each electronic device 200 includes the unique identifier of the BMC 201.

The processing module 30 obtains the number of times that the start and shut down operation has been completed from the test file of each of electronic device 200, compares the obtained number of the times that the start and shut down operations have been completed with the total number of the times the user set, and controls the signal generating module 20 to generates a stop command to control the electronic device 200 to stop starting and shutting down if the obtained number of the times that the start and shut down operations has been completed is equal to the total number of the times set by the user. In this embodiment, the processing module 30 further obtains a system time from the BMC 201 of each of the electronic device 200, calculates and records a time length for starting each of the electronic devices 200 each time, and calculates an average time length, a longest time length, and a shortest time length for starting each electronic device 200 according to the recorded time length for the starting of each of the electronic devices 200 each time.

The analyzing module 40 obtains the test file from each electronic device 200, and analyzes the stability of each electronic device 200 by analyzing the test result records in the test file. For example, the analyzing module 40 analyzes the stability of each electronic device 20 by determining whether the temperature value and the voltage value of the main board recorded in the test file is in a preset range, in detail, if determining that the temperature value and the voltage value of the main board recorded in the test file of an electronic device 200 is within the preset range, the analyzing module 40 determines that the electronic device 200 is stable, otherwise, the analyzing module 40 determines that the electronic device 200 is unstable. In this embodiment, the analyzing module 40 analyzes the stability of each electronic device 200 further according to the average time length, the longest time length, and the shortest time length for starting each electronic device 200 calculated by the processing module 30, in detail, the analyzing module 40 determines that the electronic device 200 is running in a stable state by determining whether the average time length, the greatest time length, and the least time length for starting each electronic device 200 is in a preset range. If determining that the average time length, the greatest time length, and the least time length for starting each electronic device 200 are all within the preset range, the analyzing module 40 determines that the electronic device 200 is stable, and otherwise, if one of the average time length, the greatest time length, and the least time length is not within the preset range, the analyzing module 40 determines that the electronic device 200 is unstable.

The output module 50 is configured to generate a notification to inform the user that the electronic device 200 is stable or unstable according to the result the analyzing module 40 determined.

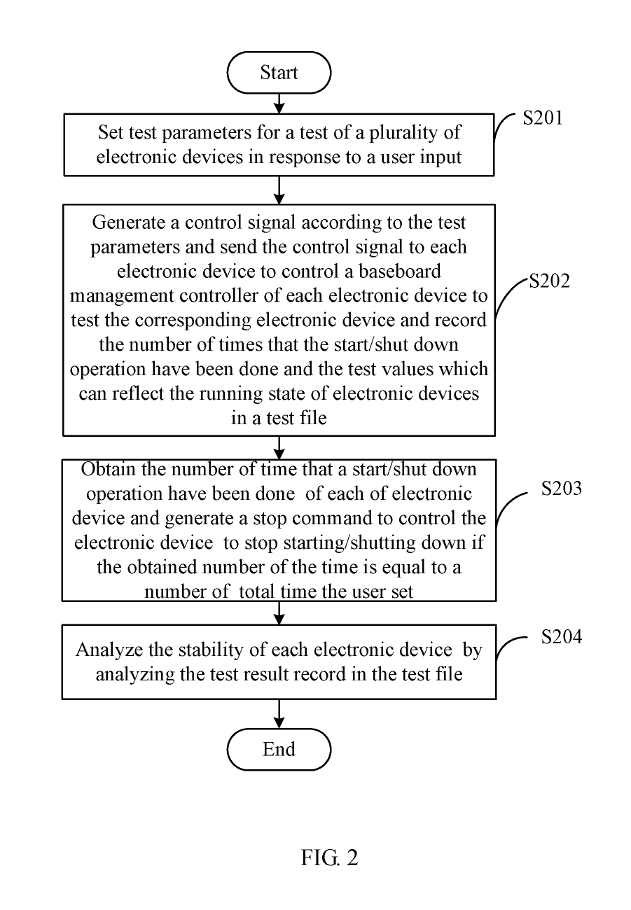

FIG. 2 is a flowchart of a test method in accordance with an exemplary embodiment.

In step S201, the parameter setting module 10 sets test parameters in response to a user input. In the embodiment, the test parameters include the total number of the times that the electronic devices 200 are to be started and shut down in the test, the time interval between two times that the electronic devices 200 are started and shut down, the items to be tested, such as the software/hardware of the electronic device 200 to be test, and the test content, such as the voltage and the temperature of the electronic device 200.

In step S202, the signal generating module 20 generates a control signal which can be recognized by the BMC 201 of each electronic device 200 according to the test parameters set by the user and sends the control signal to the BMC 201 of each of the electronic devices 200 to control the BMC 201 to test the corresponding electronic devices 200 according to the test parameters. In the embodiment, when testing the electronic devices 200, each electronic device 200 is controlled to be started and shut down according to the parameter set by the user, and record the number of times that the start and shut down operation have been done and the test values which can reflect the running state of the electronic devices 200, such as the temperature value and the voltage value of the main board of the electronic device 200, in a test file.

In step S203, the processing module 30 obtains the number of times the start and shut down operation has been completed from the test file of each of electronic device 200, compares the obtained number of the times that the start and shut down operation has been completed with the total number of the times set by the user, and controls the signal generating module 20 to generates a stop command to control the electronic device 200 to stop starting and shutting down if the obtained number of the times that the start and shut down operation has been completed is equal to the total number of the times set by the user. In this embodiment, the processing module 30 further obtains a system time from the BMC 201 of each of the electronic device 200, calculates and records a time length for starting each of the electronic devices 20 each time, and calculates an average time length, a longest time length, and a shortest time length for starting each electronic device 200 according to the recorded time length for starting each electronic device 200 each time.

In step S204, the analyzing module 40 obtains the test file from each electronic device 200, and analyzes the stability of each electronic device 200 by analyzing the test result record in the test file. In this embodiment, the analyzing module 40 analyzes the stability of each electronic device 200 further according to the average time length, the longest time length, and the shortest time length for starting each electronic device 200 calculated by the processing module 30.

In step S205, the output module 50 is configured to generate a notification to inform the user that the electronic device 200 is stable or unstable according to the result the analyzing module 40 determined

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A test device configured for simultaneously testing stability of a plurality of electronic devices, the test device comprising:
a storage unit;
a processor;
one or more programs stored in the storage unit, executable by the processor, the one or more programs comprising:
a parameter setting module to set test parameters for a test in response to a user input, wherein the test parameters comprises a total number of times that each electronic device is to be started and shut down in the test, a time interval between two times that the electronic device are started and shut down, items to be tested, and a test content for each item;
a signal generating module to generate a control signal which can be recognized by a baseboard management controller of each electronic device according to the test parameters and send the control signal to the baseboard management controller of each electronic device to control the baseboard management controller to test the corresponding according to the parameter set by the user, and record the number of the time that the start and shut down operation have been done and the test values which can reflect the running state of each electronic device in a test file; and
an analyzing module to obtain the test file from each electronic device, and analyze the stability of each electronic device by analyzing the test result record in the test file.

2. The test device as described in claim 1, the one or more programs further comprises a processing module to obtain the number of the time that the start and shut down operation have been done from the test file of each of electronic device, and controls the signal generating module to generate a stop command to control the electronic device to stop starting and shutting down if the obtained number of the times that the start and shut down operation have been done is equal to the total number of the times the user set.

3. The test device as described in claim 2, wherein the processing module further obtains a system time from the baseboard management controller of each of the electronic device, calculates and records a time length for starting each of the electronic devices each time, and calculates an average time length, a longest time length, and a shortest time length for starting each electronic device according to the recorded time length.

4. The test device as described in claim 3, wherein the analyzing module analyzes the stability of each electronic device further according to the average time length, the longest time length, and the shortest time length for starting each electronic device calculated by the processing module, in detail, the analyzing module determines that the electronic device is running in a stable state by determining whether the average time length, the greatest time length, and the least time length for starting each electronic device is in a preset range, if determining that the average time length, the longest time length, and the shortest time length for starting each electronic device are all with the preset range, the analyzing module determines that the electronic device is stable, and otherwise, the analyzing module determines that the electronic device is unstable.

5. The test device as described in claim 1, the one or more programs further comprises an output module to generate a notification to inform the user the test result the analyzing module determined.

6. A test method for testing the stability of a plurality of electronic devices, comprising:
setting test parameters for a test of a plurality of electronic devices in response to a user input;
generating a control signal according to the test parameters and sending the control signal to a baseboard management controller of each electronic device to control the baseboard management controller to test the corresponding electronic devices according to the parameter set by the user, and recording the number of the time that the start and shut down operation have been done and the test values which can reflect the running state of the electronic devices in a test file;
analyzing the stability of each electronic device by analyzing the test result record in the test file.

7. The test method as described in claim 6, wherein before analyzing the stability of each electronic device by analyzing the test result record in the test file, the method further comprising:
obtaining the number of the time that the start and shut down operation have been done from the test file of each of electronic device, and generating a stop command to control the electronic device to stop starting and shutting down if the obtained number of the times that the start and shut down operation have been done is equal to the total number of the times the user set.

8. The test method as described in claim 6, wherein the test parameters comprises a total number of times that the electronic devices are to be started and shut down in the test, a time interval between two times that the electronic devices are started and shut down, items to be tested, and a test content.

9. The test method as described in claim 6, further comprising:
obtaining a system time from the baseboard management controller of each electronic device, calculating and recording a time length for starting each of the electronic devices each time, and calculating an average time length, a longest time length, and a shortest time length for starting each electronic device according to the recorded time length.

10. The test method as described in claim 9, further comprising:
analyzing the stability of each electronic device further according to the average time length, the longest time length, and the shortest time length for starting each electronic device calculated by the processing module, in detail, determining that the electronic device is running in a stable state by determining whether the average time length, the longest time length, and the shortest time length for starting each electronic device is in a preset range, if determining that the average time length, the greatest time length, and the least time length for starting each electronic device are all with the preset range, determining that the electronic device is stable, and otherwise, determining that the electronic device is unstable.

11. A computer-readable medium comprising program instructions for testing a stability of electronic devices, the program instructions which when executed by a computer system causes the computer system to execute a method comprising:
setting test parameters for a test of a plurality of electronic devices in response to a user input;
generating a control signal according to the test parameters and sending the control signal to a baseboard management controller of each electronic device to control the baseboard management controller to test the corresponding electronic devices according to the parameter set by the user, and recording the number of the time that the start and shut down operation have been done and the test values which can reflect the running state of the electronic devices in a test file;
analyzing the stability of each electronic device by analyzing the test result record in the test file.

12. The computer-readable medium as described in claim 11, wherein the method execute by the program instructions in the computer-readable medium further comprising:
obtaining the number of the time that the start and shut down operation have been done from the test file of each of electronic device, and generating a stop command to control the electronic device to stop starting and shutting down if the obtained number of the times that the start and shut down operation have been done is equal to the total number of the times the user set.

13. The computer-readable medium as described in claim 12, wherein the method executed by the program instructions in the computer-readable medium further comprising:
analyzing the stability of each electronic device further according to the average time length, the longest time length, and the shortest time length for starting each electronic device calculated by the processing module, in detail, determining that the electronic device is running in a stable state by determining whether the average time length, the longest time length, and the shortest time length for starting each electronic device is in a preset range, if determining that the average time length, the greatest time length, and the least time length for starting each electronic device are all with the preset range, determining that the electronic device is stable, and otherwise, determining that the electronic device is unstable.

14. The computer-readable medium as described in claim 11, wherein the test parameters comprises a total number of times that the electronic devices are to be started and shut down in the test, a time interval between two times that the electronic devices are started and shut down, items to be tested, and a test content.
